(19) United States
(12) Patent Application Publication
(10) Pub. No.: US 2010/0071617 A1
(43) Pub. Date: Mar. 25, 2010

(54) PAINT BOOTH

(75) Inventor: Bansei Nagase, Tokyo (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/525,017

(22) PCT Filed: Jan. 16, 2008
(86) PCT No.: PCT/JP2008/050431

§ 371 Date: Jul. 29, 2009

(30) Foreign Application Priority Data
Jan. 30, 2007 (JP) 2007-018644

(51) Int. Cl. B05B 15/12

(52) U.S. Cl. 118/326

(57) ABSTRACT

A paint booth that eliminates paint mist from air containing paint mist and volatile organic compounds (VOC) generated within a paint room in a highly-efficient manner is provided.

The paint booth includes a collecting chamber that holds booth circulating water and is provided with a forced contact section having curved guide plates. An end section of each of the guide plates is provided with a water surface plate. The water surface plates are made of plate-shaped members and are disposed above the surface of the booth circulating water that serves as collecting water, such that a necessary space between the water surface plates and the water surface is maintained. Preferably, the water surface plates are formed in a flat or corrugated sheet shape.

### TECHNICAL FIELD

The present invention relates to a paint booth which can collect paint and can provide reusable air by bringing the air in the paint booth containing the paint mists and the volatile organic compounds (VOC) into contact with a collecting fluid.

### BACKGROUND ART

In a painting process for an automobile body, the body which is an object to be coated is mounted on a carrier of a conveyor and is coated by a spray gun provided on a paint robot while the body is passing through the inside of a paint booth of a tunnel shape. In this case, spray coating using paints of different colors is carried out through simultaneous parallel processing within the paint booth. Accordingly, there is a possibility that the paint (i.e., paint mist) which has not adhered to the automobile body will adhere to the surface of another body to which a different painting color is to be applied and thus, the coating quality deteriorates. It is therefore necessary to immediately collect the paint mist without diffusing the mist within a paint room.

Patent Document 1 proposes that a plurality of water-conducting plates which are zigzag disposed to lower their ends, is provided in a collecting chamber provided below a paint room, a plurality of water curtains is formed by circulating the collecting water along the surface of the water-conducting plates, and non-adhering paint contained in a current of air can be eliminated by causing the air current to pass through the water curtain.

Patent Document 2 discloses that a flow plate on the surface of which a water film is formed by running water overflowing an upper water tank into a lower water tank is disposed within a collecting chamber of a paint booth and a baffle plate passage is also provided to overflow the paint mist, collected by gas-liquid contact between the air and the running water sucked onto the reverse side of the flow plate from a suction opening which is provided on the lower end of the flow plate, into a lower water tank.

Patent Document 1: Japanese Patent No. 3104137

Patent Document 2: Japanese Patent No. 2641607

### DISCLOSURE OF THE INVENTION

### Problem to be Solved by the Invention

In the collecting device as disclosed in Patent Document 1, collection of the paint mist by the water curtains is effective to a certain extent as a pretreatment for releasing the paint mist into the air, but this is insufficient to clean the air to such a level as to be reusable within the paint booth.

In the paint booth of Patent Document 2, the flow plate surface is provided on which the same water film as in Patent Document 1 is formed and air is cleaned by the gas-liquid contact in the suction opening which is provided on the lower end of the flow plate. However, since the gas-liquid contact surface is only a small area of the suction opening, this is insufficient to clean the air to such a level as to be reusable within the paint booth.

### MEANS FOR SOLVING THE PROBLEM

In order to attain this object, according to the present invention, a paint booth is provided, in which a collecting chamber is provided below a paint room for coating a coating object to be conveyed to communicate with the paint room, a current of air flowing from the top down is formed within the paint room, and the current of air is brought into contact with a collecting fluid to collect paint mist, wherein the collecting chamber is provided with a forced contact section adapted to bring the current of air into contact with falling water, an opening is formed on the lower end of the forced contact section to face the collecting fluid stored in the collecting chamber, and a water surface plate is provided toward the outside from the vicinity of the opening to maintain a fixed space between the water surface plate and the surface of the collecting fluid stored in the collecting chamber.

With the provision of the water surface plate, it is possible to increase the possibility of bringing a current of air flowing out of the forced contact section into contact with the surface of the collecting fluid stored in the collecting chamber and also to increase the collection rate of the paint mist. The narrower the space between the water surface plate and the surface of the collecting fluid, the higher the possibility of contact. However, if the space is too narrow, the suction resistance of the airflow becomes large to make the collection rate less efficient. Likewise, the larger the area of the water surface plate, the higher the possibility of contact. However, if the area is too large, the suction resistance of the airflow becomes large.

Further, the current of air flowing from the top down is formed within the paint booth, wherein the intensity of an exhaust fan is adjusted so that the flow rate of the current of air can be 0.2 m to 1 m per second. In this manner, using an existing exhaust fan, and in order to control the flow rate of the current of air within the paint booth at 0.2 m to 1 m per second, it is desirable that the water surface plate have a width of 100 mm to 600 mm toward the outside from the opening, and the space between the surface of the collecting fluid stored in the collecting chamber and the water surface plate be set between 20 mm and 160 mm.

### EFFECTS OF THE INVENTION

The paint booth according to the present invention is provided in such a manner that the water surface plate is disposed above the surface of the collecting fluid stored in the collecting chamber to maintain a space between the fluid surface and the water surface plate and air containing the paint mists and the volatile organic compounds (VOC) is introduced into the space to be brought into full contact with the collecting fluid. In this manner, air can be cleaned for repeated use in the paint booth.

As a result of an experiment, in the case where the water surface plate is not provided in the paint booth, the collection rate of paint mist was 85%. On the contrary, when the water surface plate is provided in the same paint booth, the collection rate of the paint mist improved up to 88%. Further, by forming the end section of the water surface plate in a shape bent toward the surface of the water, the collection rate of the paint mists improved up to 90%.

Since the air to be finally released into the atmosphere is also clean as a result of treatment in the collecting chamber according to the present invention, it is possible to lessen the burden on the exhaust system.

### BRIEF DESCRIPTION OF THE DRAWINGS

FIG. 1 A schematic view showing an entire depiction of a paint booth according to the present invention;

FIG. 2 A perspective view of the paint booth;

FIG. 3 A cross-sectional view showing the details of a collecting chamber of the paint booth according to the present invention;

FIG. 4 An enlarged view of an essential part of FIG. 3;

FIG. 5 A view similar to FIG. 4 showing a modified example of a water surface plate according to the present invention;

FIG. 6 A cross-sectional view similar to FIG. 3 explaining another embodiment; and

FIG. 7 An enlarged view of an essential part of FIG. 6.

### BEST MODE FOR CARRYING OUT THE INVENTION

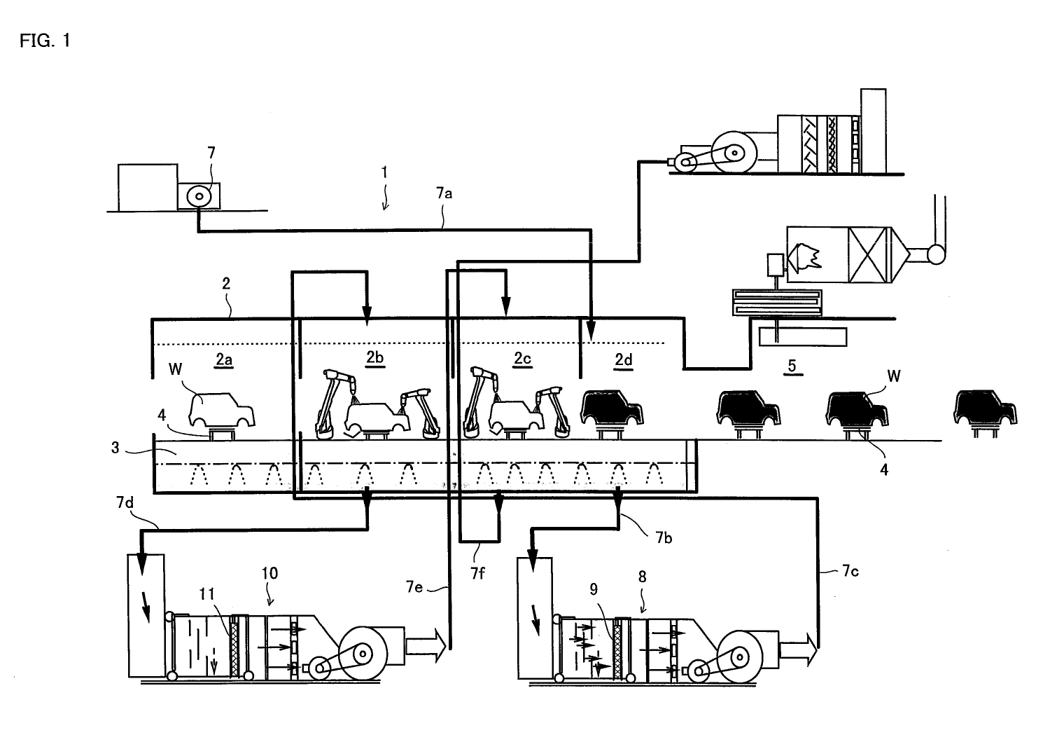

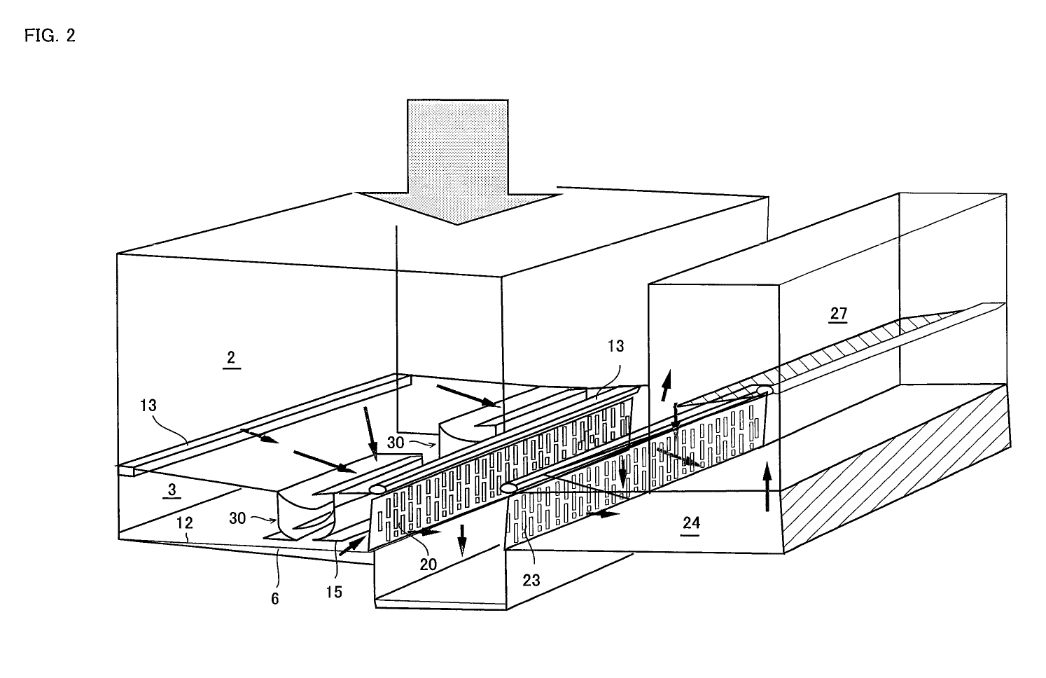

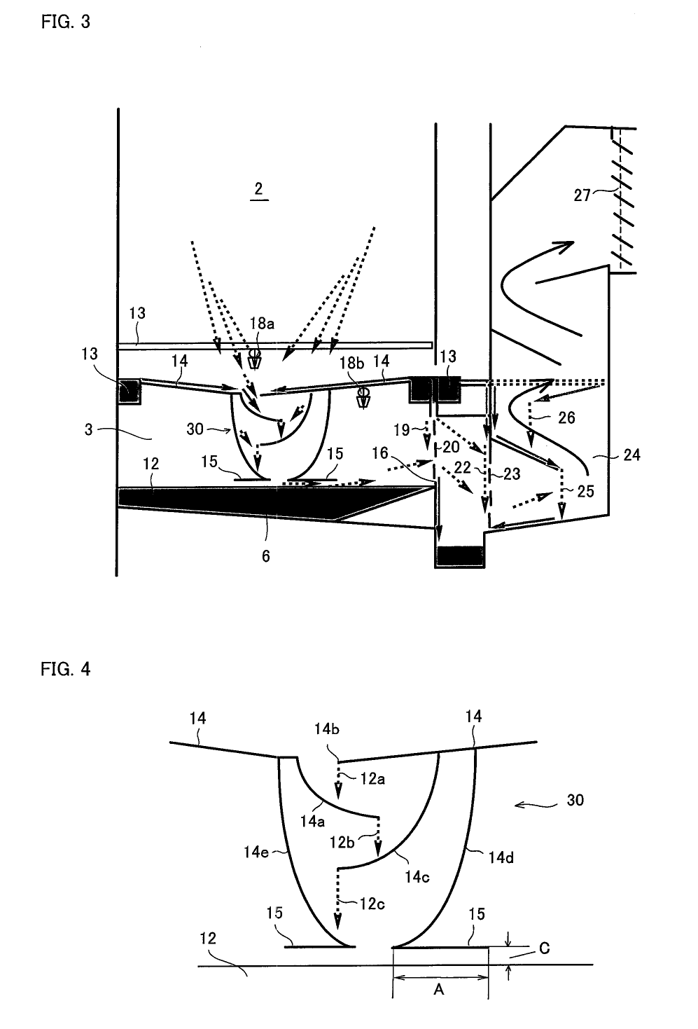

A preferred embodiment of the present invention will now be described with reference to the accompanying drawings. FIG. 1 is a schematic view showing an entire depiction of a paint booth according to the present invention and FIG. 2 is a perspective view of the paint booth. FIG. 3 is a cross-sectional view showing the details of a collecting chamber.

A paint booth 1 is provided with a paint room 2 and a collecting chamber 3. The paint room 2 consists of a body cleaning chamber 2a for cleaning an object W to be coated (an automobile body, here), an interior spray-coating chamber 2b, an exterior spray-coating chamber 2c, and a corrective spray-coating chamber 2d. The object W be coated is mounted on a carrier 4 on a conveyor, is conveyed to these chambers in sequence, and is coated by a paint robot on the way. The coating of object W is completed through heating in a drying process 5.

The collecting chamber 3 provided below the paint room 2 is provided with a circulating water flow tank 6 at the bottom section in which a collecting fluid is stored. Paint mist described below is collected by circulating the collecting fluid vertically.

The flow of air will now be explained. Fresh air 7a is sent to the upper section of the corrective spray-coating chamber 2d from an air conditioner 7 serving to air-condition the booth to prevent the paint mist from being diffused within the paint room 2. It is to be noted that the destination of the fresh air 7a is not limited to the corrective spray-coating chamber 2d. However, there is merit in this method by which the foulness of the fresh air 7a can be minimized because the amount of the paint mist generated within the corrective spray-coating chamber 2d is smaller than in the interior spray-coating chamber 2b and the exterior spray-coating chamber 2c.

Air 7b containing the paint mist and the volatile organic compounds (VOC) after flowing down through the corrective spray-coating chamber 2d is cleaned within the collecting chamber 3 and the water content is eliminated from the air 7b by an eliminator plate 9 within a first secondary air regeneration unit 8 to become secondary air 7c.

The secondary air 7c is sent to the interior spray-coating chamber 2b. The destination of the secondary air 7c is not limited to the interior spray-coating chamber 2b, but the interior spray-coating chamber 2b is a desirable destination in the respect that contamination of the secondary air 7c can be reduced because the amount of paint mist generated in the interior spray-coating chamber 2b is smaller than in the exterior spray-coating chamber 2c. The secondary air 7d containing the paint mist after flowing down through the interior spray-coating chamber 2b is cleaned within the collecting chamber 3 and the water content is eliminated from the air 7d by an eliminator plate 11 within a second secondary air regeneration unit 10 to become tertiary air 7e.

The tertiary air 7e is then sent to the exterior spray-coating chamber 2c. Tertiary air 7f containing a considerable quantity of paint mist after flowing down through the exterior spray-coating chamber 2c is sent to an exhaust system after the paint mist is collected within the collecting chamber 3 and is cleaned before being released into the atmosphere.

FIG. 3 shows the details of the collecting chamber 3 which is a main component of the present invention. FIG. 4 is an enlarged view of an essential part of FIG. 3 and is the view of the paint room 2 and the collecting chamber 3 as seen from the conveying direction of the object W to be coated. In FIG. 3, the paint room 2 can be any one of the interior spray-coating chamber 2b, the exterior spray-coating chamber 2c and the corrective spray-coating chamber 2d.

The collecting chamber 3 is provided with a circulating water flow tank 6 at the bottom section thereof. Booth circulating water 12 (i.e., a collecting fluid) stored in the circulating water flow tank 6 separates the paint mist collected by a filter and the like and is then forced up into upper side grooves 13, 13. The booth circulating water 12 overflowing the upper side groove 13 flows along inclined plates 14, 14 provided to extend from the side of the upper side groove 13.

Provided below the inclined plate 14 is a forced contact section 30 of a pot shape adapted to bring a current of air into contact with falling water. As shown in FIG. 2, a plurality of forced contact sections 30 of a pot shape is provided along the conveying direction of the object W to be coated.

The forced contact section 30 is provided in such a manner that a guide plate 14a with a curved surface is provided on an end section of one inclined plate 14 and the booth circulating water 12 falling to the guide plate 14a from an end section 14b of another inclined plate 14 forms a first waterfall gate 12a. The inclined plate 14 provided with the end section 14b is also provided with additional guide plates 14c and 14d with curved surface on the lower side along the inclined section, while the inclined plate 14 provided with the guide plate 14a is provided with a guide plate 14e with a curved surface on the lower side along the inclined section. In this manner, the booth circulating water 12 which falls forming the first waterfall gate 12a forms a second waterfall gate 12b by falling to the guide plate 14c from the end section of the guide plate 14a. The booth circulating water 12 further forms a third waterfall gate 12c by falling to the guide plate 14e from the end section of the guide plate 14c.

The number of waterfall gates can be selectively determined keeping the capacity and shape of the paint booth in mind. A conventional straight and oblique shape of guide plate can be used in place of the curved guide plates 14a, 14c, 14d and 14e.

Each end section of curved guide plates 14d and 14e is provided with a water surface plate 15 which is a main component of the present invention. The water surface plates 15, 15 are made of a plate-shaped member and are disposed above the surface of the booth circulating water 12 serving as a collecting fluid to maintain a necessary space between the water surface and the water surface plates 15, 15. It is desirable that the water surface plates 15, 15 be formed in a flat or corrugated sheet and have a width of 100 mm to 600 mm (A) toward the outside from a lower opening of the forced contact section 30. In the case where the width is less than 100 mm, the contact between the air and the booth circulating water 12 may be insufficient. On the contrary, if the width is more than 600 mm, the load for letting the air pass may become excessive, thus having an adverse effect on the air conditioner 7.

It is also desirable that a gap (C) between the water surface plates 15, 15 and the surface of the booth circulating water 12 be between 20 mm and 160 mm. However, the gap is not necessarily constant over the length of the water surface plates 15, 15. For example, by narrowing the gap on each end section side of the guide plates 14d and 14e and gradually broadening the gap toward the outside, it is possible to prevent entrainment of the booth circulating water 12 used in formation of the waterfalls and to facilitate air release. In the case where the gap is below 20 mm, the booth circulating water 12 may be entrained or the load to let the air pass may become excessive, thus affecting the air conditioner 7. On the contrary, if the gap is more than 160 mm, the contact between the air and the booth circulating water 12 may become insufficient. There is no limit to a method of adjusting the gap. However, for example, the surface of the fluid can be selectively heightened or lowered by installing a tank level adjuster 16 on an overflow section of the circulating water flow tank 6.

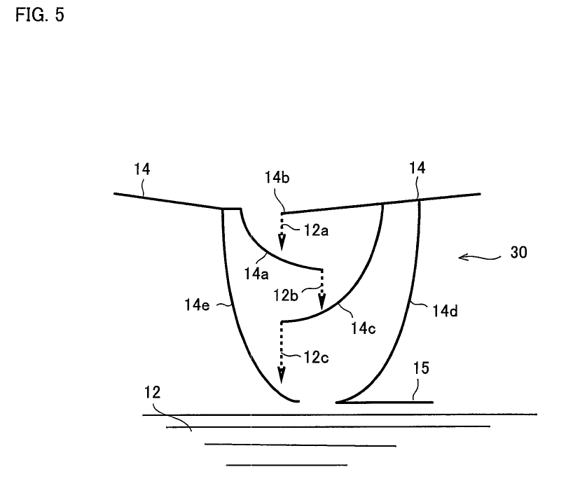

As shown in FIG. 5, the water surface plate 15 can be installed only on one side facing an exhaust duct 21 described below. In such a shape, the load to let the air pass can be lessened and the load on the air conditioner 7 can also be reduced.

Since the collecting chamber 3 is composed as described above, air 7b, 7d and 7f containing the paint mist generated in the paint room 2 flows downward to the collecting chamber 3 through a paint room floor 17 to contact the booth circulating water 12 flowing along the inclined plates 14, 14. In this manner, almost all the paint mist is absorbed by the booth circulating water 12 in the process in which the air 7b, 7d and 7f pass through the first waterfall gate 12a, the second waterfall gate 12b and the third waterfall gate 12c. To facilitate the absorption of the paint mist into the booth circulating water 12, a gelling agent for flocculating the paint mist can be sprayed from a spray 18a disposed right above the forced contact section 30 of a pot shape and a spray 18b disposed within the collecting chamber 3.

The air passing through the third waterfall gate 12c then gets into under the water surface plates 15, 15, advances under the water surface plates 15, 15 while being pushed against the surface of the booth circulating water 12, and is released.

Then, the air passes through a booth side water curtain 19 and a booth dust catcher slit gate 20 on the side of the collecting chamber 3 and passes further through a chamber water curtain 22 and a chamber dust catcher slit 23 to move to an exhaust chamber 24.

In the exhaust chamber 24, the air passes through exhaust chamber water curtains 25, 26, in that order, to move upward and exits from a double eliminator 27 to be sent to a secondary air regeneration unit 8 or 10 for reuse. Alternatively, the treated air used in the exterior spray-coating chamber 2c is sent to an exhaust system for cleaning and is released into the atmosphere.

As shown in the figure, part of the booth circulating water 12 can be used for an exhaust duct circulating water which forms the booth side water curtain 19, the chamber water curtain 22, and the exhaust chamber water curtains 25 and 26.

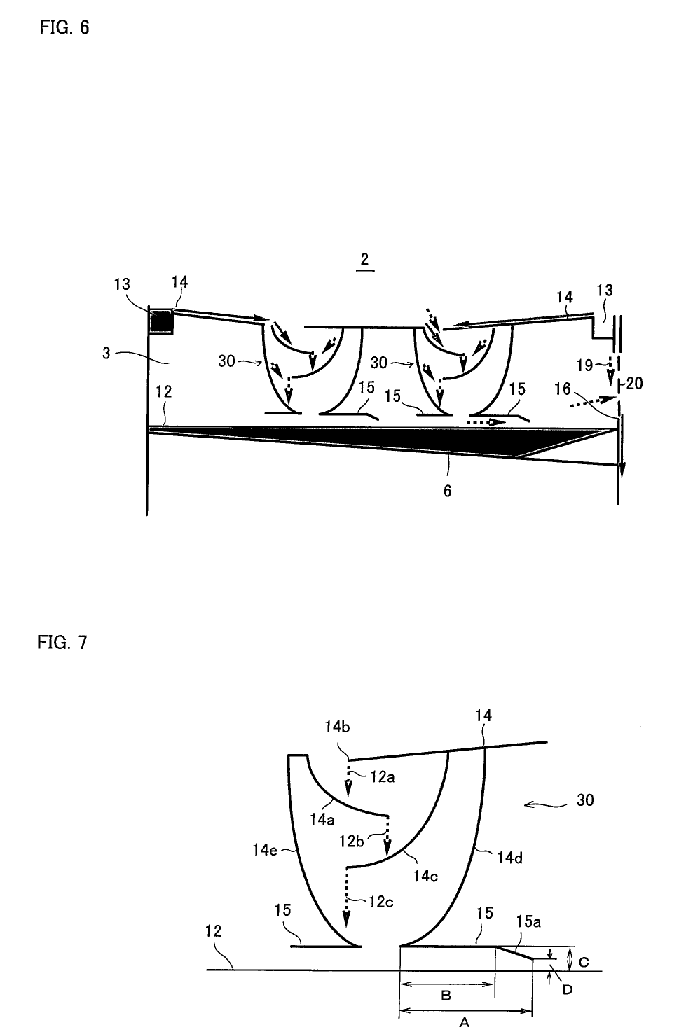

FIG. 6 is a cross-sectional view similar to FIG. 3 explaining another embodiment and FIG. 7 is an enlarged view showing an essential part of FIG. 6. In this embodiment, a pair of forced contact sections 30 of a pot shape is provided in the direction perpendicular to the conveying direction of the object W to be coated and an edge section 15a of the water surface plate 15 is bent toward the water surface so that mist can be collected without difficulty. In this embodiment, the width (A) and the gap (C) are the same as in the previous embodiment, but a width (B) which does not include the edge section 15a is set between 75 mm and 490 mm and a gap (D) between the outermost side of the edge section 15a and the water surface is set between 15 mm and 80 mm.

In the paint booth of the present invention, when a water-based paint is used, the regeneration air can be used as is. However, when a solvent-type paint is used, it is desirable that the air treated by the secondary air regeneration unit 8 or 10 be further led to a VOC (volatile organic compounds) eliminator to eliminate about 95 to 98% of the volatile organic compounds before reuse.

### INDUSTRIAL APPLICABILITY

The paint booth according to the present invention is provided in such a manner that air can be cleaned in a highly-efficient manner for repeated use and even in the case where the air is finally exhausted into the atmosphere, it does not burden an exhaust system. In this manner, the paint booth can be suitably applied not only to spray coating of an automobile body, but also to all kinds of coating such as automobile parts and plastic products.

1. A paint booth having a collecting chamber provided below a paint room, wherein the paint room is for coating an object to be coated and conveyed and the collecting chamber stores a collecting fluid and is in communication with the paint room, wherein a current of air flowing from the top down is formed in the paint room, and the current of air is brought into contact with the collecting fluid to collect paint mist, wherein the collecting chamber includes a forced contact section adapted to bring the current of air into contact with falling water, the forced contact section having an opening formed on a lower end to face the collecting fluid stored in the collecting chamber, and
wherein the force contact section includes a water surface plate that extends from a vicinity of the opening formed in the forced contact section toward an outside of the collecting chamber, wherein the water surface plate is disposed so as to maintain a fixed space between a surface of the collecting fluid stored in the collecting chamber and the water surface plate.

2. The paint booth according to claim 1, wherein the water surface plate has a width of 100 mm to 600 mm toward the outside of the collecting chamber from the opening, and
the space between the surface of the collecting fluid stored in the collecting chamber and the water surface plate is set between 20 mm and 160 mm.
